(19) United States
(12) Patent Application Publication
(10) Pub. No.: US 2005/0113197 A1
(43) Pub. Date: May 26, 2005

(54) Bidirectional belt tensioning approach

(75) Inventor: William Y. Pong, Portland, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/721,386

(22) Filed: Nov. 25, 2003

(51) Int. Cl. F16H 7/14; F16H 7/12

(52) U.S. Cl. 474/117; 474/133; 474/114

(57) ABSTRACT

A live center belt-drive uses a biasing moment to induce automatically adjusted and reoriented tensioning resultant force in a belt and pulley system. Embodiments have a motor mounted on a plate freely pivotably mounted to a frame of a device in which the tensioner is used. The motor is connected to a drive pulley and drives a driven pulley via a belt reeved about the drive and driven pulleys. A. first biasing mechanism biases the drive pulley away from the driven pulley, thus providing the biasing moment M_{bias}. Embodiments use a linear spring providing a biasing force F_{bias} and mounted a distance d_{bias} from the pivot point to provide the biasing moment M_{bias} about the pivot point. Alternatively, embodiments use a torsion spring mounted about the pivot point to provide the biasing moment M_{bias}. Embodiments can also employ a second biasing mechanism to bias the driven pulley away from the drive pulley.

### FIELD OF THE INVENTION

The invention relates to devices for varying tension in belts of a device according to operation of the device.

### BACKGROUND AND SUMMARY

Various approaches have traditionally been taken in the design of belt drive systems to provide adequate belt tension, and therefore adequate drive torque capacity, throughout useful life of the drive. In a fixed-center drive approach, an initial tension is applied to the belt, and then the roller or pulley centers are fixed in place. In this arrangement, a large initial tension must be applied in anticipation of tension loss over the life of the drive. In a linear, live-center drive arrangement, one or both of the pulleys are linearly tensioned away from one another. In a backside/inside tension arrangement, such as that shown in FIG. 1, a drive pulley and a driven pulley 3 are drivingly connected via a belt 4. The drive pulley 2 receives motive power from a motor 5. One or more idler pulleys 6 is biased against the inside or the outside of the belt 4 to induce tension. An example of a biasing mechanism is a spring 7 between the idler pulley 6 and a frame 8 of the device in which the pulley system is used.

These approaches are subject to one or more of several obstacles or drawbacks Such drawbacks include mechanism complexity; unintended drive dynamics due to the live center arrangement and/or tensioner mechanism; accelerated component wear due to large belt loads and/or reverse bending of belts; uncompensated tension variation due to such factors as belt stretch, frame creep, component wear, component runout (including belt runout), and dimensional changes due to temperature or humidity variations.

Embodiments employ a new live center approach in which one pulley is tensioned away from the other or both of the pulleys are tensioned away from each other, but in a pivoting fashion, as opposed to the linear fashion of the prior art. This exploits the fact that the resultant belt load on the pulleys reorients when torque is applied to the system. Embodiments employ a geometry such that as torque is applied in a particular direction, belt tension increases proportionally without requiring an additional mechanism. Likewise, when torque is applied in a direction opposite to the particular direction, belt tension decreases proportionally. Thus, many of the drawbacks of prior art devices are overcome with embodiments.

### BRIEF DESCRIPTION OF THE DRAWINGS

FIG. 1 is a schematic representation of a prior art tensioner.

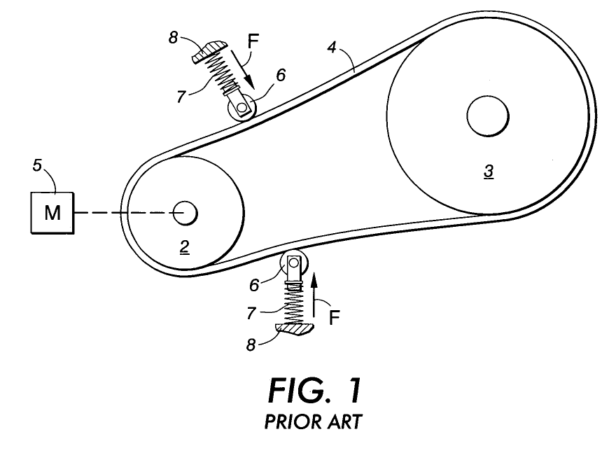

FIG. 2 is a schematic representation of a tensioner of embodiments.

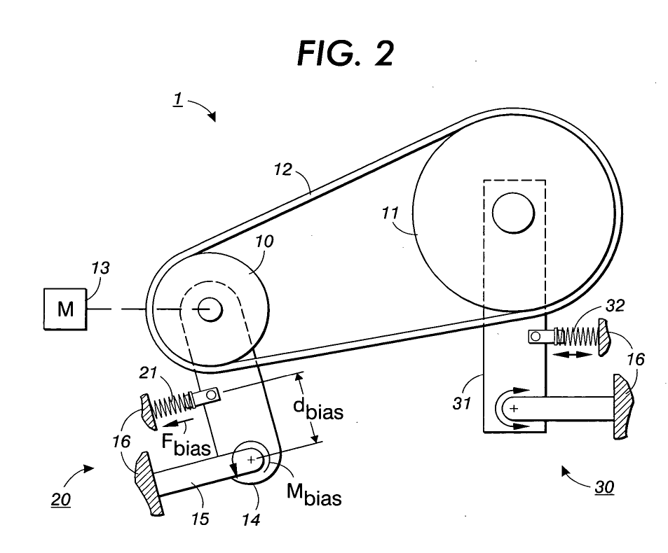

FIG. 3 is a schematic representation of another tensioner of embodiments.

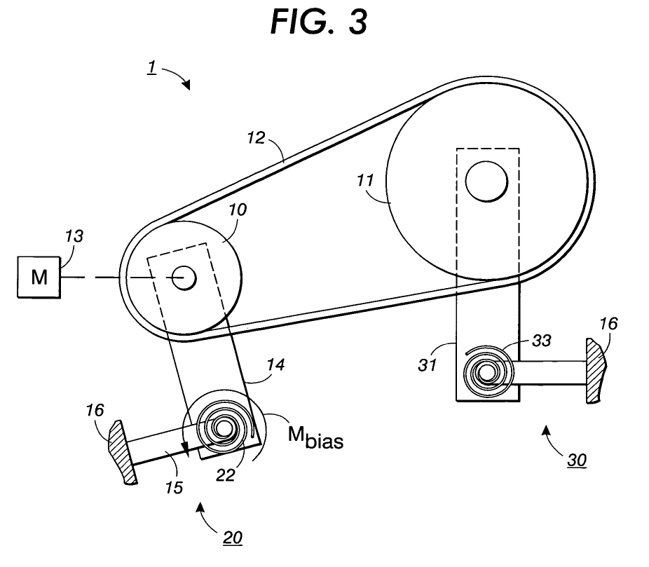

FIG. 4 is a schematic representation of another tensioner of embodiments.

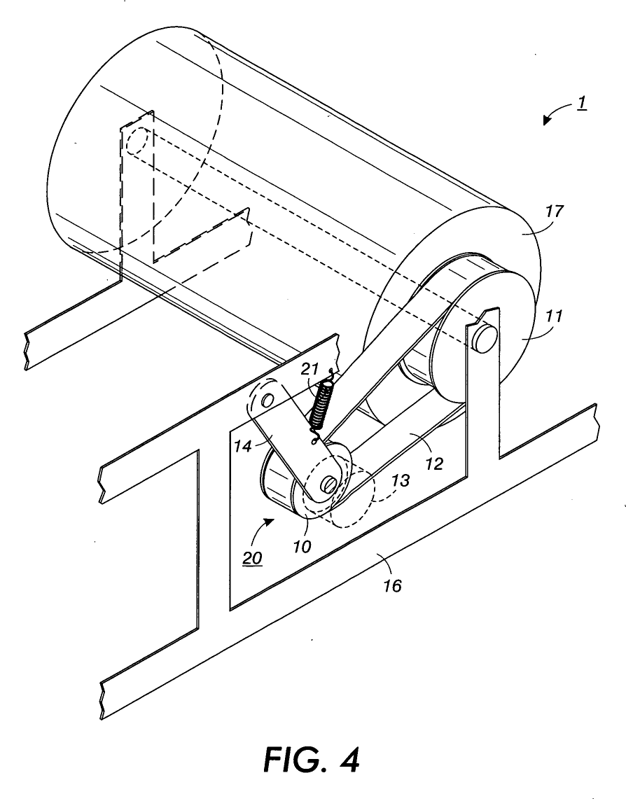

FIG. 5 is a more general schematic representation of a tensioner of embodiments.

FIG. 6 is a general schematic representation of a tensioner of embodiments.

### DESCRIPTION

For a general understanding of the present invention, reference is made to the drawings. In the drawings, like reference numerals have been used throughout to designate identical elements.

Embodiments comprise a live center belt tensioner 1 in which a first pulley 10, preferably a drive pulley, is biased away from a second pulley 11, preferably a driven pulley. The first and second pulleys 10, 11 are drivingly connected via a belt 12. The drive pulley 10 receives rotational motive power from a motor 13, which it then transfers to the driven pulley 11 via the belt 12. The motor 13 is preferably mounted on a motor mount 14, such as a motor plate. The motor mount 14 has a freely pivotable connection 15 to a frame 16 of the device in which the tensioner is used. The driven pulley 11 is preferably connected to a rotating element 17 of the device. For example, in embodiments deployed in a marking device, the rotating element can be a print drum, a fuser roll, or the like, though other elements could be driven with the tensioner of embodiments.

Embodiments employ a first biasing mechanism 20 to bias the first pulley 10 away from the second pulley 11 in a pivoting fashion, thus placing tension in the belt 12. The first biasing mechanism 20 induces a biasing moment M_{bias} such as, for example, upon the motor plate, about the pivot point or connection 15. For example, in embodiments, a linear spring 21 can be attached to the motor mount 14 and to the frame 16 of the device. Preferably, the linear spring 21 would have a preload to place tension on the belt and would be mounted a distance d_{bias} from the pivot point to provide an initial M_{bias}=d_{bias}×F_{bias} about the pivot point 15, where F_{bias} initially is the preload of the spring 21. Alternatively, embodiments can employ a torsional spring 22 mounted about the pivot point 15 and preloaded to induce an initial M_{bias} about the pivot point. Preferably, the position of the pivot point on the motor plate is chosen so as to exploit the fact that the belt strand tensions redistribute when torque is applied to the system. Embodiments employ a geometry such that as torque is applied in a particular direction, belt tension increases proportionally without requiring an additional mechanism.

Embodiments can also have a second biasing mechanism 30 biasing the second pulley 11 away from the first pulley 10 so that both of the pulleys 10, 11 are tensioned away from each other, but again in a pivoting fashion, as opposed to the linear fashion of the prior art. A mounting plate 31 or the like can be employed between the second pulley 11 and the frame 16 in a fashion similar to that of the motor mount 14. The connection between the mounting plate 31 and the frame 15 is preferably freely pivotable. A linear spring 32, a torsion spring 33, or the like is preferably employed to provide the bias of the second pulley 11 away from the first pulley 10.

Embodiments can be used, for example, in marking machines. Embodiments can be used in phase change ink jet marking machines. Embodiments are also suitable for use in electroreprographic, electrophotographic, and electrostatographic marking machines, such as xeroreprographic multifunction copiers/printers.

In operation, when no torque is applied, a resultant force F₀ of the belt, upon the motor-motor plate assembly, for example, acts along a line of action that is a distance d₀ from the pivot point of the motor plate. The action of the resultant force F₀ at the distance d₀ creates a moment M₀ that is at equilibrium with the moment M_{bias} generated by the biasing element. When torque is applied by the motor, the belt strand-tensions redistribute. As a consequence, the belt-resultant force acts along a new line of action that is a new distance d₁ from the pivot point. Since the moment of the belt-resultant about the pivot must remain constant (that is, equilibrium with M_{bias} must be maintained), this change in moment arm results in a corresponding change in the magnitude of the belt resultant.

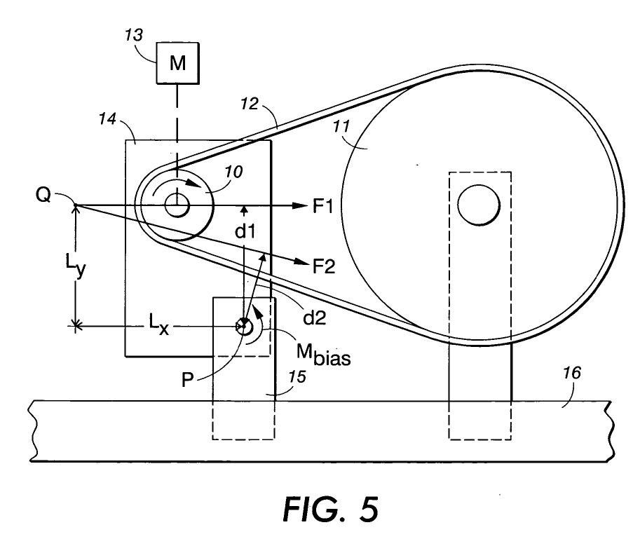

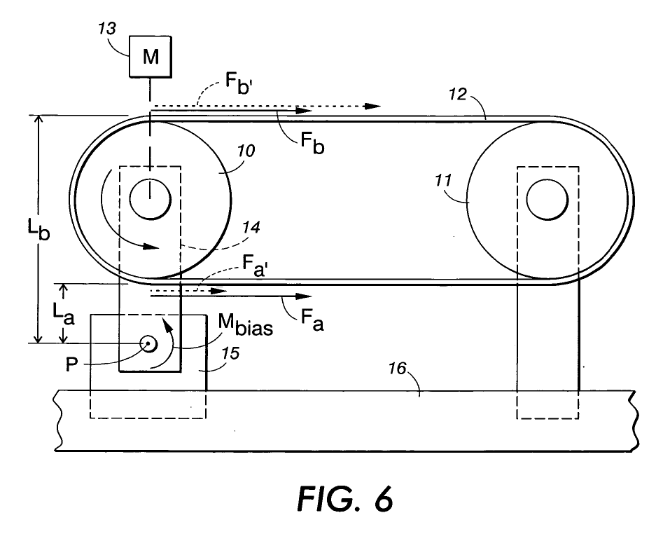

By way of a more general explanation, referring to FIGS. 5 and 6, P represents the pivot point of a motor mounting plate whose positioning with respect to Q, the intersection of belt strands and virtual point of action of belt resultant, can allow one to employ embodiments. The theoretical intersection of the belt-strands “Q” is useful for analysis of the drive. Lₓ and L_{y} represent the position of P with respect to Q. F₁ and F₂ are the resultant belt load and are the vector sum of the belt strand tensions under different conditions. F₁ is an initial belt resultant in which no motor torque is applied, while F₂ is the belt resultant with torque applied. F₂ has a different orientation than F₁ because of unequal strand tensions generated by the application of torque. Each resultant F₁ and F₂ has a moment arm d₁ and d₂ about the pivot point P resulting in a respective moment M₁ and M₂.

In operation, initially there is no torque applied and a biasing moment M_{bias} is applied to the motor plate via the biasing element, such as a torsional spring at the pivot point or a linear spring attached at d_{bias} from the pivot point. M_{bias} induces an initial tension in the belt strands, the resultant of which is F₁. M₁ must be equal and opposite to M_{bias}. When motor torque is applied, the resultant belt load reorients as F₂, which creates the moment M₂, which must likewise be equal and opposite to M_{bias}. In the exemplary embodiment of FIG. 5, d₂ is less than d₁, which means that F₂ must be greater than F₁, which in turn means that belt load increases when motor torque is applied. By appropriately tuning the pivot point location, greater drive capacity can be achieved, according to embodiments. Note that when a motor torque of opposite sense is applied to the exemplary system of FIG. 5, the belt load, and drive capacity, is reduced. The pulleys need not be of different size to allow application of embodiments, as seen, for example, in FIG. 6. Here, analysis of the moment contributions of the individual belt strands about the pivot point can be done.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A live center belt tensioner comprising:
first and second pulleys;
a belt reeved over the first and second pulleys;
a first biasing mechanism tensioning the first pulley away from the second pulley in a pivoting fashion; and
belt load on the pulleys thereby reorienting when torque is applied.

2. The tensioner of claim 1 employing a geometry such that as torque is applied, belt tension varies proportionally.

3. The tensioner of claim 1 further comprising:
a drive motor on which the first pulley is mounted, the first pulley comprising a drive pulley;
a motor plate on which the drive motor is mounted and that is in turn attached to a frame a device in which the motor is employed; and
a freely pivoting connection between the motor plate and the frame.

4. The tensioner of claim 1 wherein the second pulley is attached to a drum of a device in which the motor is employed.

5. The tensioner of claim 1 wherein the motor plate is biased away from the driven pulley by the first biasing mechanism so as to induce tension in the belt.

6. The tensioner of claim 1 wherein the first biasing mechanism comprises a spring that generates a biasing moment M_{bias} about the pivot point.

7. The tensioner of claim 6 wherein the first biasing mechanism is a linear force device mounted at a distance d_{bias} from the pivot point.

8. The tensioner of claim 6 wherein the first biasing mechanism comprises a torsional spring mounted about the pivot point.

9. The tensioner of claim 1 further comprising a second biasing mechanism that tensions the second pulley away from the first pulley.

10. A belt tensioner comprising:
a pivoting motor mount attached to a frame;
a pivot point of the pivoting motor mount about which the pivoting motor mount pivots and via which the pivoting motor mount is attached to the frame;
a first pulley attached to the pivoting motor mount and receiving motive power from a motor mounted on the pivoting motor mount;
a second pulley attached to an element of a machine in which the tensioner is used;
a belt reeved over the first pulley and the second pulley, thereby transferring motive power from the motor to the second pulley via the first pulley; and
a first biasing device attached to the pivoting mount and biasing the first pulley away from the second pulley such that changes in motive power from the motor result in changes in biasing moment on the pivoting motor mount, as well as belt tension.

11. The tensioner of claim 10 employing a geometry such that as torque is applied, belt tension varies proportionally.

12. The tensioner of claim 10 wherein the motor mount comprises a motor plate on which the drive motor is mounted and that is in turn attached to a frame of a device in which the tensioner is employed, and the motor plate is attached to the frame via a freely pivoting connection between the motor plate and the frame.

13. The tensioner of claim 10 wherein the second pulley is attached to a drum of a device in which the motor is employed.

14. The tensioner of claim 10 wherein the motor mount is biased away from the driven pulley by the first biasing mechanism so as to induce tension in the belt.

15. The tensioner of claim 10 wherein the first biasing mechanism comprises a spring that generates a biasing moment M_{bias} about the pivot point.

16. The tensioner of claim 15 wherein the first biasing mechanism is a linear force device mounted at a distance d_{bias} from the pivot point.

17. The tensioner of claim 15 wherein the first biasing mechanism comprises a torsional spring mounted about the pivot point.

18. The tensioner of claim 10 further comprising a second biasing mechanism that tensions the second pulley away from the first pulley.

19. The tensioner of claim 18 wherein the second biasing mechanism is a linear force device mounted at a distance d_{bias} from the pivot point.

20. The tensioner of claim 18 wherein the second biasing mechanism comprises a torsional spring mounted about the pivot point.

21. In a marking device comprising a frame, a media path and a rotating element driven by a motor via a belt, a drive pulley, and a driven pulley, the belt being reeved over the drive pulley and the driven pulley, a tensioner comprising a pivoting motor mount attached to the frame via a freely pivoting connection at a pivot point, a first biasing mechanism arranged to induce a biasing moment M_{bias} about the pivot point, and belt load on the pulleys thereby reorienting when torque is applied.

22. The tensioner of claim 21 arranged such that as torque is applied, belt tension varies proportionally.

23. The tensioner of claim 21 wherein the second pulley is attached to a drum of a device in which the motor is employed, the drum comprising a part of the media path.

24. The tensioner of claim 21 wherein the motor plate is biased away from the driven pulley by the first biasing mechanism so as to induce tension in the belt.

25. The tensioner of claim 21 wherein the first biasing mechanism comprises a spring that generates a biasing moment M_{bias} about the pivot point.

26. The tensioner of claim 25 wherein the first biasing mechanism is a linear force device mounted at a distance d_{bias} from the pivot point.

27. The tensioner of claim 25 wherein the first biasing mechanism comprises a torsional spring mounted about the pivot point.

28. The tensioner of claim 21 further comprising a second biasing mechanism that tensions the second pulley away from the first pulley.

29. The tensioner of claim 28 wherein the second biasing mechanism is a linear force device mounted at a distance d_{bias} from the pivot point.

30. The tensioner of claim 28 wherein the second biasing mechanism comprises a torsional spring mounted about the pivot point.

31. The tensioner of claim 21 wherein the marking device is a phase change ink jet device.

32. The tensioner of claim 21 wherein the marking device is an electroreprographic device.
